(19) United States
(12) Patent Application Publication
(10) Pub. No.: US 2008/0288389 A1
(43) Pub. Date: Nov. 20, 2008

(54) SYSTEMS AND METHODS FOR PROVIDING EMBEDDED RECEIVER NOTES

(75) Inventors: Ashees Jain, New York, NY (US); Morgan Baumann, New York, NY (US); Ashutosh Tripathi, Montclair, NJ (US); Ralph Lentini, Maplewood, NJ (US)

Correspondence Address: MORGAN LEWIS & BOCKIUS LLP, 1111 PENNSYLVANIA AVENUE NW, WASHINGTON, DC, 20004, US

(73) Assignee: Lehman Brothers Inc., New York, NY (US)

(21) Appl. No.: 11/972,723

(22) Filed: Jan. 11, 2008

Related U.S. Application Data
(60) Provisional application No. 60/879,972, filed on Jan. 11, 2007.

(51) Int. Cl. G06Q 40/00

(52) U.S. Cl. 705/37

(57) ABSTRACT

Systems and methods are provided for providing an embedded receiver note which includes a swaption embedded in a bond. If a reference rate exceeds a strike rate of the swaption, a note holder receives a par value of the note. If the reference rate is lower than the strike rate of the swaption, the note is extended with an exercised swaption.

### PRIORITY APPLICATION

This application claims the benefit of U.S. Provisional Patent Application No. 60/879,972, filed Jan. 11, 2007, Systems and Methods for Providing Embedded Receiver Notes. The entire contents of that application are incorporated herein by reference.

### INTRODUCTION

As a result of pension reforms, accounting and regulatory changes, investors are increasingly focused on interest rate risk management. Investors are seeking investment products that have a long duration and a positive convexity profile have historically been limited to a few types of instruments. Convexity is the rate of change of duration of a security with respect to changes in the yield-to-maturity of the security. Typically, bonds with higher coupon rates have lower convexity. A zero coupon bond has the highest convexity. Comparing convexity of bonds with similar characteristics (e.g., duration and yield) is useful because it indicates an effect on the bond if interest rates change. Generally, bonds with higher convexity have a higher price than bonds with a lower convexity.

One common investment product with a long duration and convexity profile is a 30-year treasury strip, or a zero-coupon bond (vanilla strip). A zero coupon bond is a bond that is typically issued at a discount from par value, pays no interest, dividend or other payment over the life of the bond, and is redeemed for par value at its maturity date. Other types of zero coupon bonds are not discounted and can be purchased for X and have a maturity value of X plus a premium.

Other products designed to have a long duration and convexity profile include a synthetic product that incorporates a long duration asset with a zero coupon swap, and a longer tenor option on a swap. However, the use of zero coupon swaps and swaptions in derivative form raises two issues. First, the investor must be able to enter into a derivative contract, and second, the investor typically must mark those products to market. The mark to market process for certain investors can introduce volatility or uncertainty into their earnings, which is often viewed unfavorably.

Systems and methods are described herein that overcome the disadvantages of existing investment instruments.

In one embodiment of the invention, a method is provided comprising: issuing a note to a noteholder, wherein the note comprises a swaption embedded in a bond; receiving a payment in return for the note; and at maturity of the note, paying a par value of the note to the noteholder, if a reference rate exceeds a strike rate of the swaption; or extending the note with an exercised swaption, if the reference rate is lower than the strike rate of the swaption. Variations of embodiments of the invention include that the swaption comprises a receiver swaption, the bond comprises a zero coupon bond, the reference rate comprises a swap rate, and/or the note comprises a credit risk substantially corresponding to a credit risk of an issuer of the bond.

In another embodiment of the invention, a method is provided comprising: receiving in return for a payment, a note comprising a swaption embedded in a bond; at maturity of the note, receiving a par value of the note, if a reference rate exceeds a strike rate of the swaption; or exercising the swaption to extend the note, if the reference rate is lower than the strike rate of the swaption.

Another embodiment of the invention is directed to a note comprising: a swaption embedded in a bond; a maturity date equal to a maturity date of the bond; and a right to receive par value of the bond at maturity if a reference rate exceeds a strike rate of the swaption, or a right to exercise the swaption if the reference rate is less than the strike rate of the swaption.

### BRIEF DESCRIPTION OF THE DRAWINGS

FIG. 1 depicts a flow diagram for an embedded receiver note according to an embodiment of the invention.

### DETAILED DESCRIPTION

Methods and systems are described herein for providing an embedded receiver note. In one embodiment of an embedded receiver note, a swaption, such as a long dated swaption, is embedded into a zero coupon bond. A swaption is typically an option which grants the holder/owner a right, but not necessarily an obligation, to enter into an underlying swap. Although options can be traded on a variety of swap transactions, a swaption typically refers to an option relating to an interest rate swap. In general, a receiver swaption is used in embedded receiver notes described herein, but as will be understood by one of skill in the art, other types of swaptions can be used. A receiver swaption is a swaption that gives the holder/owner of the swaption the right to enter into a swap where they will receiver the fixed leg of the swap and pay the floating leg of the swap. Typically a receiver swaption provides an enhanced payment if interest rates have fallen below a projected forward interest swap rate. An exemplary embodiment of an embedded receiver note is provided according to the terms of Appendix A.

Among other advantages of the invention, embedding the long dated swaption into the zero coupon bond provides a longer duration profile and typically, a more positively convex profile than a treasury strip, or the original zero-coupon bond. Since the combination of the zero coupon bond and swaption can be provided in a bond form, an investor can limit counterparty risk to that of the issuer. Another advantage of embedding a receiver note is that investors can receive favorable accounting treatment based on certain aspects of the instrument, e.g., parameters relating to the length of the bond, the strike of the swaption, or other parameter.

In embodiments of the invention which embed a swaption in a zero coupon bond, the bond issuer's credit rating can be leveraged. Generally, zero coupon bond issuers have high credit ratings, which makes the asset have a relatively minimal credit risk. For example, if a zero coupon bond issuer has a triple A rating, an issuing counterparty facing the resulting embedded receiver note would maintain the triple A rating. This is in contrast to a derivative format in which the counterparty would typically be an entity other than the bond issuer and would have its respective credit rating, which may differ from the credit rating of the bond issuer. In such a format an investor would be subject to the risk of different credit ratings of the issuer and counterparty.

Embodiments of the embedded receiver notes are generally not marked to market under accounting rules, e.g., Financial Accounting Standards Board (FASB) 133, because of the swaption, zero-coupon swap, and parameters such as tenor, and strike, used in the note.

As mentioned herein, a long-dated swaption is typically used in embodiments of the invention. Long dated can mean any relatively long duration, e.g., 20 years or more. Long dated liabilities (e.g., pensions) need a similarly long dated duration asset. A mismatch between an asset and liability duration can create a reinvestment risk.

To mitigate such risk, certain investment strategies can be used. For example, investment products should seek to have low credit risk and be cash efficient. Generally, such an instrument is a highly rated note with a credit strength of AA- or better, e.g., a U.S. Treasury. However, the need for high credit and cash efficient instruments has resulted in significant demand for U.S. Treasuries, which has led to an increased yield for such treasuries. This may cause the U.S. Treasuries to be more expensive and impact return requirements for inventors seeking long duration hedging instruments.

Embodiments of the invention provide an alternative to U.S. Treasury investments and also provide a greater yield, and risk (e.g., interest rate) protection with a credit risk similar to that of a U.S. Treasury. Generally, embedded receiver notes have the following qualities:

Credit: “AAA” Credit quality

Yield: Higher or Equivalent to comparable maturity stripped U.S. Treasuries.

Embedded receiver notes are designed to provide protection in the event that interest rates fall by increasing duration and accrual rates. In the event that a reference rate (e.g. a 10 year or 20 year swap rate, or other rate) rises, the embedded receiver notes will have the same duration as a corresponding maturity zero-coupon note. The embedded receiver note is provided with minimum cash outlay, similar to a zero-coupon bond, which optimizes risk return profile.

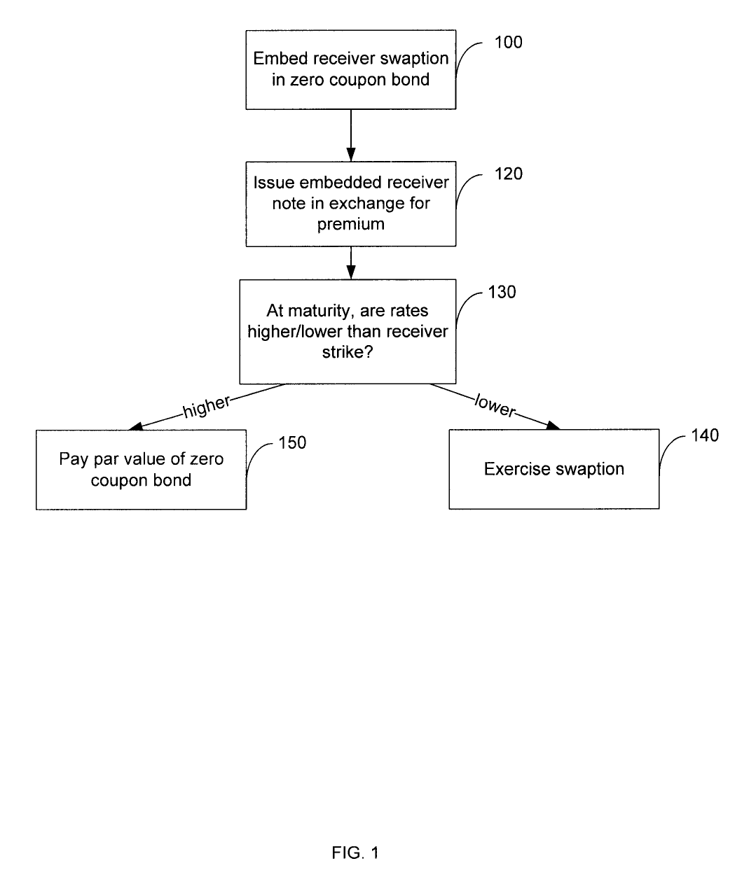

Referring to FIG. 1, a receiver swaption (or other swaption) is embedded into a zero coupon bond, step 100. Embedding the swaption in the zero coupon bond can be provided according to the parameters of the following exemplary Table 1, according to the terms of Appendix A, or other parameters as will be understood by one of skill in the art.

TABLE 1
Embedded Receiver Notes - “AAA” Protection for
50 Years (30 Y Asset = 20 Y Receiver Swaption).

| Issuer: | AAA Issuer |
|---|---|
| Offering Price: | 25.75 |
| Final Maturity: | Feb. 15, 2036 |
| Callable: | None |
| Coupon | Zero |
| Redemption: | 100% + F* MTM Value of 20 year ATMF |
| | receiver swaption, where F is leverage factor |
| Receiver Swaption | Strike: 5.09%, Expiry Feb. 15, 2036 and Maturity |
| Details: | Feb. 15, 2056 |
| Day Count: | 30/360 |

The MTM value of the Receiver swaption would be determined by the pricing agent and would be a function of the 20y swap rate as of the option expiry date.

For comparative purposes, maturity and pricing of this exemplary embodiment is designed to match the maturity and yield of the longest dated treasury used for duration management.

Leverage factor “F” is a function generally related to the credit spread of the AAA issuer. For this analysis F=0.75. However, other factors may also be used.

Referring again to FIG. 1 the embedded receiver note is issued to a noteholder in exchange for a premium, e.g., the offering price of Table 1, Issue Price of Appendix A, or other calculated premium, step 120.

At the time of maturity, e.g., 30 years, the parties (issuer and noteholder) may determine whether interest rates are higher or lower than the strike or reference swaption, step 130. If rates are lower than the 20 year swap rate at the time of maturity, the embedded receiver note provides a duration extension which has an above par payout and the noteholder can exercise the swaption, step 140. If rates are higher than the 20 year swaption strike rate, the investor receives the marked to market value of the receiver swap, step 150.

It will be appreciated that the present invention has been described by way of example only, and that the invention is not to be limited by the specific embodiments described herein. Improvements and modifications may be made to the invention without departing from the scope or spirit thereof.

Embodiments of the present invention comprise computer components and computer-implemented steps that will be apparent to those skilled in the art. For example, calculations and communications can be performed electronically, and agreements can be composed, transmitted and executed electronically.

For ease of exposition, not every step or element of the present invention is described herein as part of a computer system, but those skilled in the art will recognize that each step or element may have a corresponding computer system or software component. Such computer system and/or software components are therefore enabled by describing their corresponding steps or elements (that is, their functionality), and are within the scope of the present invention.

### APPENDIX A

### Interest Rate Structured Products

30 YR Zero Coupon Note Indicative Terms & Conditions

| | |
|---|---|
| Issuer: | TBD |
| Principal Amount: | $100,000,000 |
| Issue Price: | 13.2568 |
| Trade Date: | TBD |
| Maturity Date: | Jan. 25, 2007 |
| Interest Payment Dates: | NA |
| Redemption Price: | 100% + Max(0, PV Swaption Value) |
| Swaption Value: | The present value of the following (the “Reference Swaption”): |
| | Party A has the option to receive 4.05% fixed on a semiannual |
| | bond basis. |
| | Party A pays Libor on a Act/360 quarterly basis for the |
| | following dates. |
| | Swap Notional: $100,000,000 |
| | Effective Date: Jan. 25, 2037 |
| | Termination Date: Jan. 25, 2057 |
| Swaption Value | 5 business days prior to maturity date |
| Determination Date: | |
| Swaption Value | PV01 * (4.05% - 20-Year CMS) * Swap National |
| Calculation: | Where: |
| | “20-Year CMS” means the rate for U.S. Dollar swaps with a |
| | maturity of 20 years, expressed as a percentage, which appears |
| | on Reuters Screen ISDAFIX1 as of 11:00 a.m., New York City |
| | time, on the Swaption Value Determanation Date. If 20-Year |
| | CMS does not appear on Reuters Screen ISDAFIX1 on the |
| | Swaption Value Determination Date, 20-Year CMS shall be |
| | determined on the Swaption Value Determination Date as if the |
| | parties had specified “USD-CMS-Reference Banks” as the |
| | applicable rate. |
| | “PV01” means the net present value of the Reference Swaption, |
| | determined in accordance with Swaption PV Determination |
| | below. |
| | “Swaption PV Determination” means that PV01 on the Swaption |
| | Value Determination Date will be determined in good faith by |
| | the Calculation Agent by requesting quotations at approximately |
| | [11:00 a.m.] on the Swaption Value Determination Date from |
| | four (4) leading dealers in the relevant market for the Reference |
| | Swaption, and selected in the sole discretion of the Calculation |
| | Agent, assuming that each dealer providing a quotation is the |
| | [Fixed Rate Payer] of the Reference Swaption. If more than |
| | three (3) quotations are obtained, PV01 will be the arithmetic |
| | mean of such quotations, without regard to the quotations having |
| | the highest and lowest values. If exactly three (3) quotations are |
| | obtained, PV01 will be the quotation remaining after |
| | disregarding the highest and lowest quotations (and for these |
| | purposes, if more than one (1) quotation has the same highest |
| | value or lowest value, then one of such quotations shall be |
| | disregarded). If two (2) quotations are obtained, PV01 will be |
| | the arithmetic mean of such quotations. If the Calculation Agent |
| | is unable to obtain at least two (2) quotations, then the |
| | Calculation Agent shall determine PV01 in good faith. |
| Day Count Convention: | 30/360 |
| Business Days: | New York |

What is claimed is:

1. A method comprising:
issuing a note to a noteholder, wherein the note comprises a swaption embedded in a bond;
receiving a payment in return for the note; and
at maturity of the note,
paying a par value of the note to the noteholder, if a reference rate exceeds a strike rate of the swaption; or
extending the note with an exercised swaption, if the reference rate is lower than the strike rate of the swaption.

2. The method of claim 1 wherein the swaption comprises a receiver swaption.

3. The method of claim 1 wherein the bond comprises a zero coupon bond.

4. The method of claim 1 wherein the reference rate comprises a swap rate.

5. The method of claim 1 wherein the note further comprises a credit risk substantially corresponding to a credit risk of an issuer of the bond.

6. A method comprising:
receiving in return for a payment, a note comprising a swaption embedded in a bond;
at maturity of the note,
receiving a par value of the note, if a reference rate exceeds a strike rate of the swaption; or
exercising the swaption to extend the note, if the reference rate is lower than the strike rate of the swaption.

7. The method of claim 6 wherein the swaption comprises a receiver swaption.

8. The method of claim 6 wherein the bond comprises a zero coupon bond.

9. The method of claim 6 wherein the reference rate comprises a swap rate.

10. The method of claim 6 wherein the note further comprises a credit risk substantially corresponding to a credit risk of an issuer of the bond.

11. A note comprising:
a swaption embedded in a bond;
a maturity date equal to a maturity date of the bond; and
a right to receive par value of the bond at maturity if a reference rate exceeds a strike rate of the swaption, or
a right to exercise the swaption if the reference rate is less than the strike rate of the swaption.

12. The note of claim 11 wherein the swaption comprises a receiver swaption.

13. The note of claim 11 wherein the bond comprises a zero coupon bond.

14. The note of claim 11 wherein the reference rate comprises a swap rate.

15. The note of claim 11 wherein the note further comprises a credit risk substantially corresponding to a credit risk of an issuer of the bond.
